(19) United States
(12) Patent Application Publication
(10) Pub. No.: US 2009/0128581 A1
(43) Pub. Date: May 21, 2009

(54) CUSTOM TRANSITION FRAMEWORK FOR APPLICATION STATE TRANSITIONS

(75) Inventors: Regis Brid, Woodinville, WA (US); Kathy K. Carper, Redmond, WA (US); Brett Samblanet, Seattle, WA (US); Neil Kronlage, Issaquah, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/942,733

(22) Filed: Nov. 20, 2007

(51) Int. Cl. G09G 5/00

(52) U.S. Cl. 345/646; 345/619

(57) ABSTRACT

An application may feature a number of application states among which a process shifts during execution of the application. A user or software developer may wish to define one or more transitions to be rendered between a first application state and a second application state, but the application development environment and operating system may provide only a limited number of general-purpose transitions. Instead, a pluggable architecture may be devised to permit a user or software developer to provide a custom transition, and to specify the rendering of the custom transition between application states. The pluggable architecture may therefore enable the user or software developer to define new transitions that are more relevant and complementary of the application states in transit.

### BACKGROUND

Software applications often interact with users through a variety of application states. For example, an application may begin in a first application state representing a main menu comprising a set of options. When the user selects an option, the application may shift to a new application state to provide the user with a new user interface and a new set of options. The user may perform some operations within this application state, or may opt to return to the main menu, or may select a third application state, etc. The various functions of the application may therefore be exposed to the user through an arrangement of application states, each of which may present the user with a particular user interface related to the functions available within the application state.

Shifting from one application state to another application state often involves disposing the objects of the prior application state (e.g., erasing the visual components from the display, stopping the playing of sounds associated with the prior application state, etc.) and rendering the objects of the next application state. However, some applications are configured to apply a transition to move between the prior application state and the next application state. For example, upon receiving a selection from a main menu presented to the user in a first application state, the application may incrementally fade out the displayed main menu and may fade in the visual elements of the user interface for the application state associated with the selected main menu option.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

This disclosure relates to software applications featuring a plurality of application states and to render a transition while transitioning between the application states. An application development environment may allow a software developer to choose from a stock library of transitions provided with the application development environment, such as cross-fading and sliding. However, a software developer may wish to design a custom transition and to configure the application to render the custom transition while transitioning between two application states. The application development environment may therefore be configured to receive (e.g., from a software designer) a custom transition module defining the custom transition, and to configure the application to render the custom transition upon transitioning between two application states that may be specified by the software developer. For example, the software developer may design a custom transition in which the user interface elements comprising a main menu in a first application state to morph into the user interface elements in a second application state representing the option selected from the main menu. The application development environment may so configure the application, e.g., by compiling the application together with the custom transition module, or by specifying the custom transition module in a user interface description associated with the application.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary cross-fading transition rendered between two application states.

FIG. 2 is a flow diagram of an exemplary method of configuring an application to render a custom transition between a first application state and a second application state.

FIG. 3 is a component block diagram of an exemplary system for configuring an application to render a custom transition between a first application state and a second application state.

FIG. 4 is an illustration of an exemplary computer-readable medium comprising processor-executable instructions configured to configure an application to render a custom transition between a first application state and a second application state.

FIG. 5A is an illustration of a vertical wipe transition rendered between a first text scene application state and a second text scene application state.

FIG. 5B is an illustration of a flying two-dimensional object transition rendered between a first two-dimensional graphical scene application state and a second two-dimensional graphical scene application state.

FIG. 5C is an illustration of a three-dimensional geometric object push transition rendered between a first three-dimensional graphical scene application state and a second three-dimensional graphical scene application state.

FIG. 5D is an illustration of an audio cross-fading transition rendered between a first audio scene application state and a second audio scene application state.

FIG. 5E is a pseudocode block illustrating an algorithm for simulating a vertical wipe between a first text scene application state and a second text scene application state.

FIG. 5F is a pseudocode block illustrating another algorithm for simulating a vertical wipe between a first text scene application state and a second text scene application state.

FIG. 5G is an illustration of a multiple-modality transition rendered between a first multiple-modality scene application state and a second multiple-modality scene application state.

FIG. 5H is an illustration of two two-dimensional graphical transitions rendered between a first two-dimensional graphical scene application state and a second two-dimensional graphical scene application state based upon a transition circumstance.

FIG. 6A is a component block diagram of another exemplary system for configuring an application to render a custom transition between a first application state and a second application state.

FIG. 6B is a component block diagram of a runtime managing an application module associated with at least one custom transition module and providing an application executing according to an application state map.

FIG. 6C is a component block diagram of yet another exemplary system for configuring an application to render a custom transition between a first application state and a second application state.

FIG. 6D is a component block diagram of yet another exemplary system for configuring an application to render a custom transition between a first application state and a second application state.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Software applications are often organized as sets of application states, where each application state presents to the user a particular set of user interface elements, information, functions, etc. Each application state may present to the user a set of user interface elements. For example, the application state may comprise a text scene, such as the pages of a book or sections of a document; or a two-dimensional graphical scene, such as a set of buttons and images comprising a menu; or a three-dimensional scene, such as a set of geometric objects rendered from a viewpoint based on ambient features such as lighting. The scene may also comprise other objects relating to the scene, e.g., sounds or video played for the user in relation to the scene, or communication with peripheral devices such as printers and force-feedback instruments.

The actions of the computer system and/or the user may trigger the transition of the software application from one application state to another. For example, an application state comprising a text scene representing the contents of a book may be configured, upon the user's completion of the book, to transition to a second application state representing the contents of another book. As another example, an application state representing a menu may be configured to transition to a new application state upon selection of a menu option by the user, or upon the passage of a designated amount of time passing without receiving a selection from the user (e.g., the selection of a default menu option, and the transition to the corresponding application state, if the user does not select an option within a designated period.) As a third example, an application state comprising a three-dimensional scene may be configured to transition to a new application state upon the user selection of an object in the three-dimensional scene.

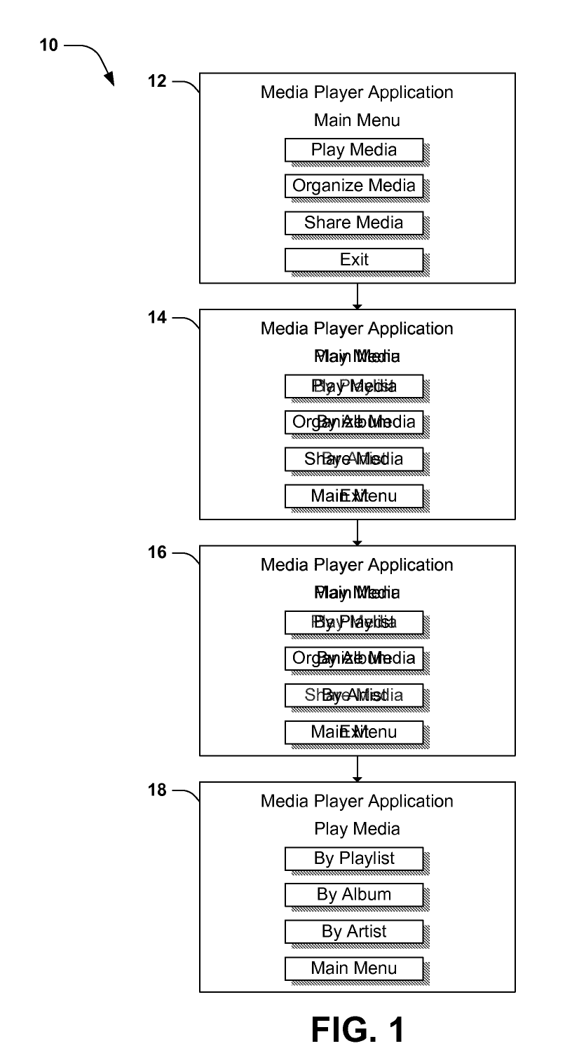

The transitions between application states are frequently omitted; e.g., the objects associated with a prior application state are instantly disposed, and the objects associated with the next application state are instantly rendered. However, a software developer or user of an application may wish to specify a transition between one application state and another application state. For example, a software developer may wish to have the visual elements comprising the first application state fade out, and then have the visual elements comprising the second application state fade in; or to have a two-dimensional graphical scene representing the first application state slide out of view, and a two-dimensional graphical scene representing the second application state slide into view; or to have the sounds comprising the first application state to fade down in volume, while the sounds comprising the second application state fade up in volume. An example 10 is illustrated in FIG. 1, which involves a transition from a first application state comprising a main menu to a second application state comprising a sub-menu corresponding to a selected option on the main menu. The example 10 begins in the first application state by displaying the main menu 12, which includes a plurality of options. Upon the user selection of the first option, the application transitions to a second application state comprising the sub-menu 18 associated with the selected option. However, the application renders a cross-fading transition between the main menu 12 and the sub-menu 18, comprising a steady fade through, e.g., a first cross-fading stage 14 and a second cross-fading stage 16. These renderings do not comprise an intermediate application state, but comprise a transition between the first application state and the second application state. Moreover, the nature of the transition may serve to indicate the type of change occurring in the application state. For example, in transitioning between the main menu 12 and the sub-menu 18, the application may display a “zooming in” transition, where the new window spawns from the menu option and grows to fill the screen; whereas in the reverse transition (an escape from the sub-menu 18 back to the main menu 12), the window comprising the sub-menu 18 may shrink and collapse into the menu option of the main menu 12. Thus, the transitions may serve to illustrate the context shift of the application, or the workflow within the application between the first application state and the second application state.

An application development environment may facilitate user in configuring the application to render such transitions between program states by offering a stock library of transitions, which the user may invoke during the transitions between application states. For example, the application development environment may offer a generic “cross-fade” visual transition, which the user may invoke as the transition between a first application state and a second application state. Upon receiving such a selection of a stock transition from the user, the application development environment may configure the application to invoke the stock transition for transitions between application states.

However, a user (e.g., a software developer) may wish to configure an application to apply a transition between two application states that is not available in the stock library of transitions. The user may be able to specify some instructions for detecting the transition of the application from one application state to another and rendering a transition. However, the user may have to write a considerable number of instructions to perform the monitoring in various portions of the application. For example, a software developer may include translucent buttons in an application, and may wish to have these translucent buttons fade into or fade out of view upon displaying or disposing any user menu that includes the translucent buttons. In order to apply this transition, the software developer may have to customize each user menu in the software application to detect the inclusion of such translucent buttons, and to render the translucent button fading transition upon displaying or disposing the user menu. For applications having many user menus, the customization of many such user menus may be time-consuming.

An alternative technique may be provided for facilitating users in specifying custom transitions between application states. A computer system may expose an interface to a user to provide a custom transition module that defines a custom transition to be rendered in an application upon transitioning between a first application state and a second application state. The custom transition module may comprise a set of computer-executable instructions configured to operate on a first application state and a second application state in order to render a transition between the application states. For example, the custom transition module may define a chroma-key blending function that operates differentially on the red, green, and blue color channels of the first application state and gradually fades each color channel in sequence from the visual objects of the first application state to the visual objects of the second application state. The computer system may be configured to receive such a custom transition module and to permit the user to specify that an application renders the custom transition during any transition from a particular application state to another particular application state (e.g., whenever a user of the targeted application selects the first option from the main menu.) The custom transition module may be created by the user, or may be designed by a third party and provided by the user (with or without further customization) for the application. In any such scenario, the “pluggable” architecture of the computer system may facilitate users and software developers in customizing the behavior of applications while transitioning between application states.

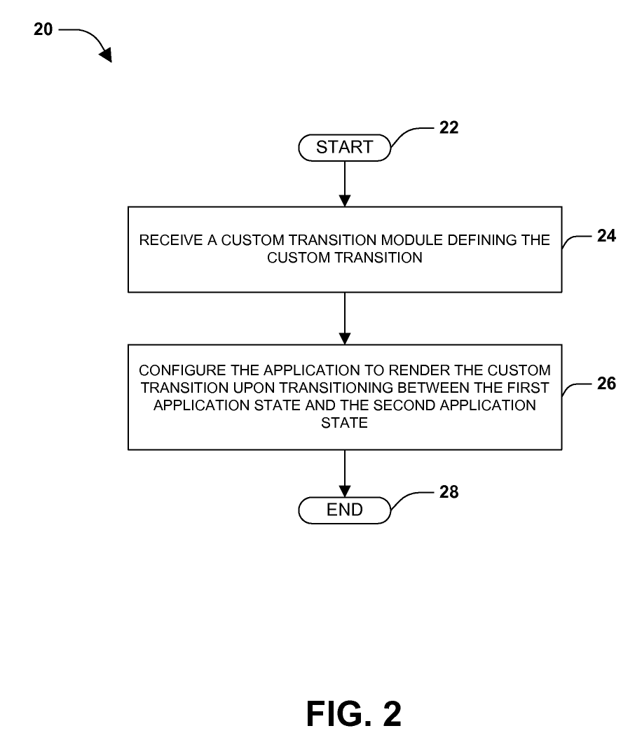

Accordingly, techniques may be devised for providing a “pluggable” architecture of this nature to couple custom transitions to applications. One such technique is illustrated in FIG. 2, which presents an exemplary method 20 of configuring an application to render a custom transition between a first application state and a second application state. The exemplary method 20 begins at 22 and involves receiving a custom transition module defining the custom transition 24. For example, the custom transition module may comprise one or more source code files, a partially or wholly compiled set of processor-executable instructions (e.g., a dynamic link library), and/or a set of declarative statements that define the characteristics of the custom transition (e.g., a description of a graphics transformation that may be applied to the application by a graphical programming interface.) The exemplary method 20 also comprises configuring the application to render the custom transition upon transitioning between the first application state and the second application state 26. Having received the custom transition module and configured the application to render the custom transitions specified therein during one or more application state transitions, the exemplary method 20 accomplishes the plugging of the custom transition module into the application, and therefore the exemplary method 20 ends at 28.

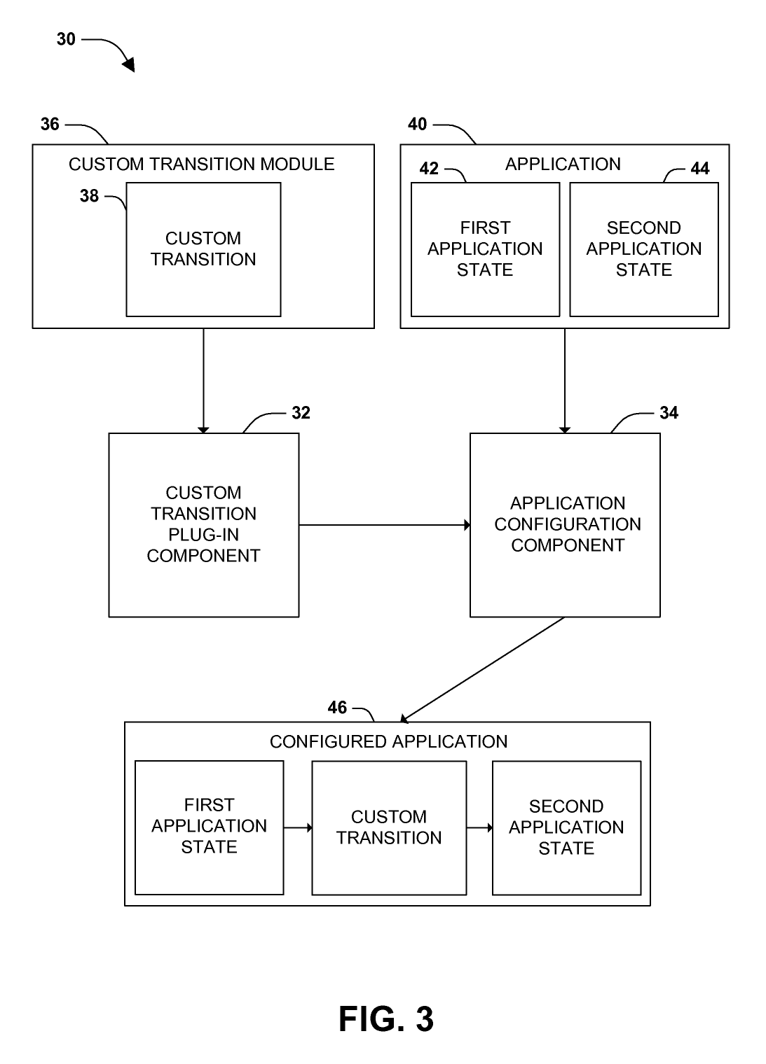

Another such technique is illustrated in FIG. 3, which presents an exemplary system 30 for configuring an application to render a custom transition between a first application state and a second application state. The exemplary system 30 of FIG. 3 includes a custom transition plug-in component 32, which is configured to receive a custom transition module 36 defining the custom transition 38. For example, the custom transition plug-in component 32 may comprise a user interface dialog that accepts input from a user, such as a software developer, comprising computer-executable instructions (e.g., source code, or a partially or wholly compiled binary, and/or a set of declarative instructions executable by a graphical application programming interface) for performing a transition between two application states. The exemplary system 30 also comprises an application configuration component 34, which is configured to configure the application 40 to render the custom transition 38 provided to the custom transition plug-in component 32 upon transitioning between the first application state 42 and the second application state 44. For example, the application configuration component 34 may comprise a user interface dialog that allows the user to specify that a particular custom transition specified in the custom transition is to be rendered by the application while transitioning between a first user form (comprising a first application state) and a second user form (comprising a second application state.) The application configuration component 34 therefore couples the application 40 with the custom transition module 36, and therefore produces a configured application 46 that renders the custom transition 38 during the transition from the first application state 42 to the second application state 44. Having produced an application configured in this manner, the exemplary system 30 achieves the configuration of the application to render the custom transition between the designated application states.

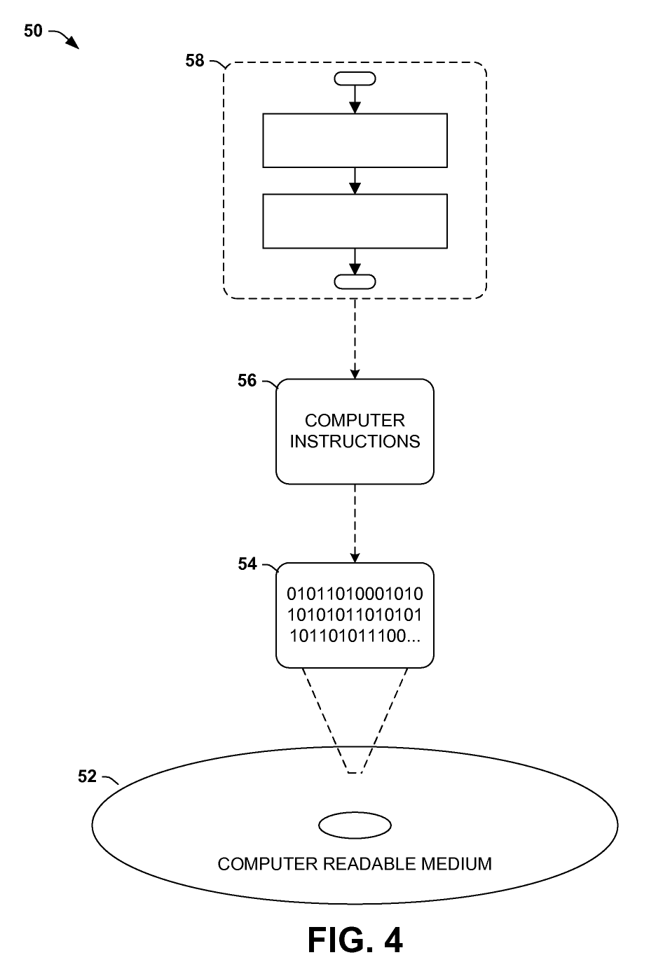

The techniques discussed herein may also be embodied as a computer-readable medium comprising processor-executable instructions configured to configure an application to render a custom transition between a first application state and a second application state. An exemplary computer-readable medium that may be devised in this manner is illustrated in FIG. 4, wherein the embodiment 50 comprises a computer-readable medium 52 (e.g., a CD-R, DVD-R, or a platter of a hard disk drive), on which is encoded computer-readable data 54. This computer-readable data 54 in turn comprises a set of computer instructions 56 configured to operate according to the principles set forth herein. In one such embodiment, the processor-executable instructions 56 may be configured to perform a method of configuring an application to render a custom transition between a first application state and a second application state, such as the exemplary method 20 illustrated in the flowchart of FIG. 2. Many such computer-readable media may be devised by those of ordinary skill in the art that are configured to operate in accordance with the techniques presented herein.

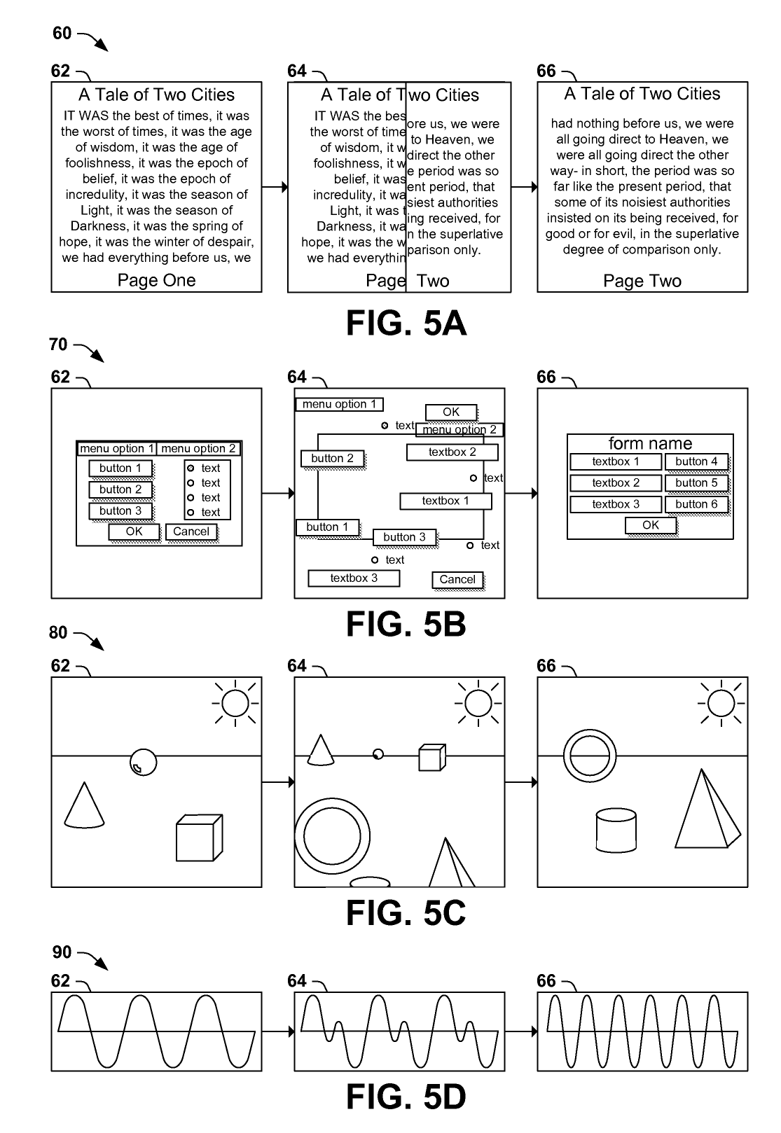

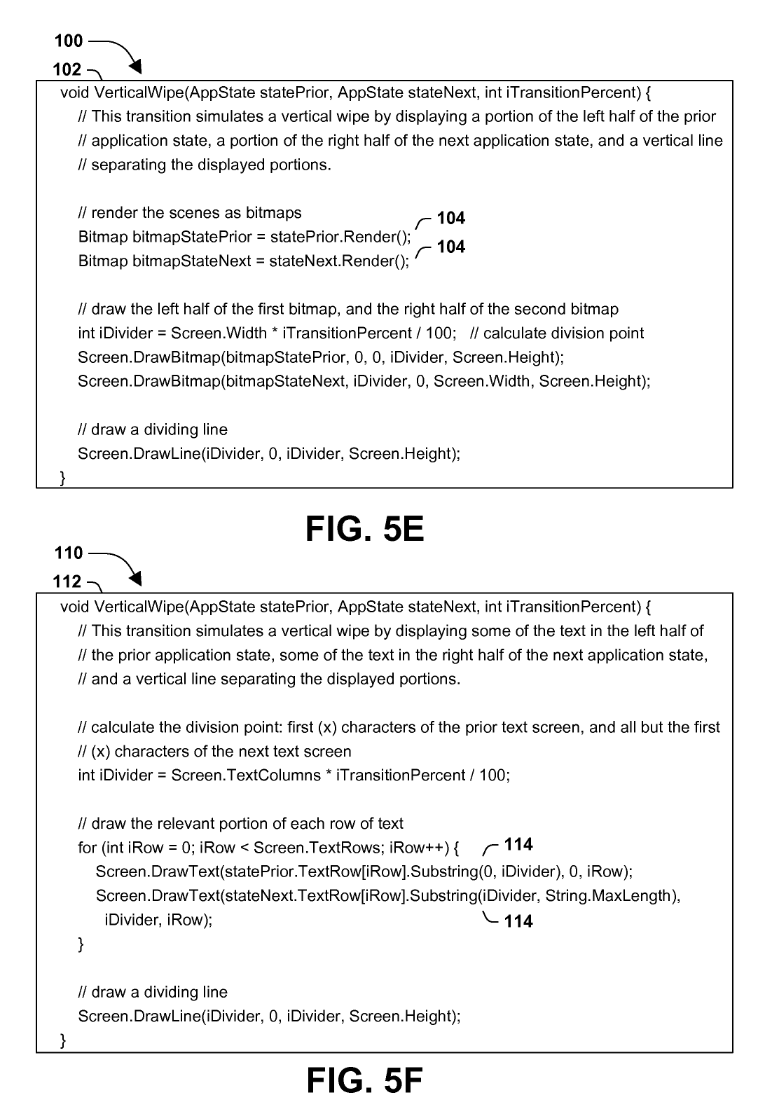

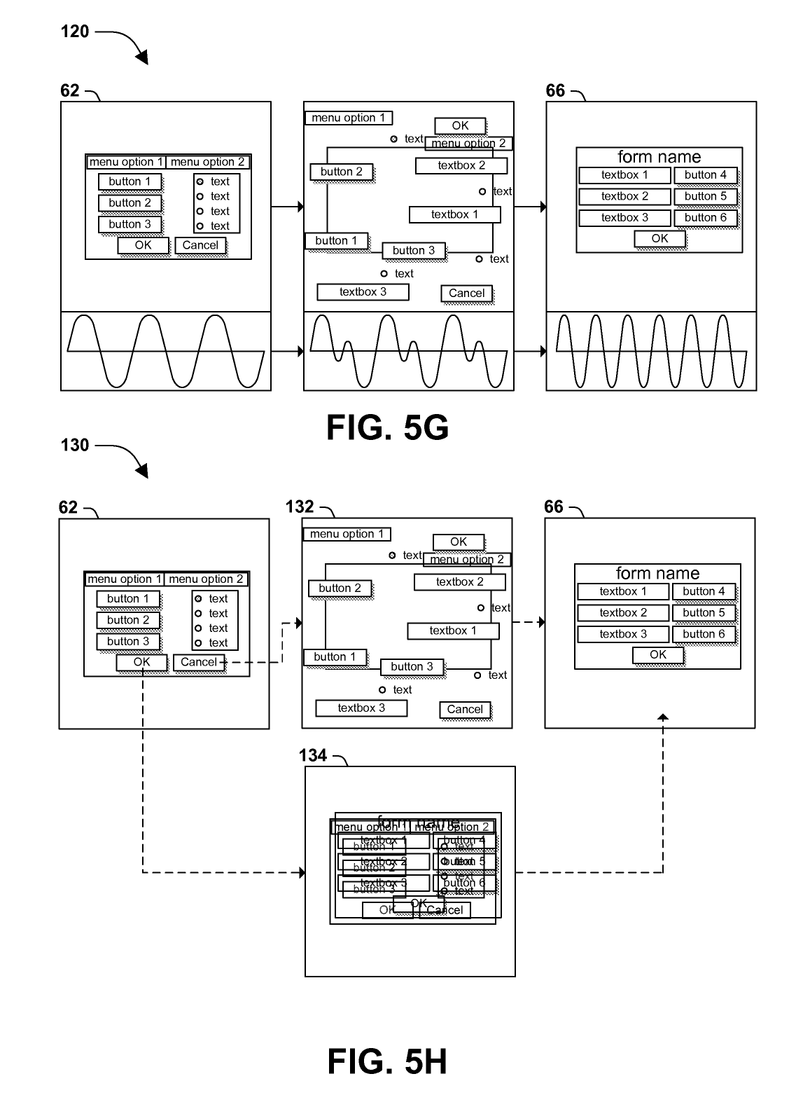

The types of application states that may be transitioned in this manner, and the types of transitions that may be rendered therebetween, may vary in a number of aspects while implementing a pluggable transition framework in accordance with the techniques described herein. As one example, the transitions provided by the user may be configured to operate on a variety of application states. FIGS. 5A-5D illustrate some examples of application states to which transitions may be applied to transition between a first application state 62 and a second application state 66 through a transition 64. Although the transition 64 is displayed in the examples of FIGS. 5A-5D as one rendering, it may be appreciated that a much larger number of renderings may be presented to provide a smooth transition between the application states.

The example 60 of FIG. 5A pertains to a transition 64 between a first application state 62 and a second application state 66, where each application state comprises a text scene. The application states in this example 60 are each configured to display a set of text, and some events may cause a transition from an application state representing one set of text to an application state representing another set of text. In this example 60, the first application state 62 is configured to display text from one page of a book, and the second application state 66 is configured to display text from another page of the book. The transition 64 is therefore rendered to transition between the pages of text. A transition of this nature therefore operates on the text objects of the scene comprising the application states. In this example 60, the transition 64 applied to the text scene displays a vertical wipe simulating the turning of the page, whereby the text comprising the first application state 62 is rendered in diminishing amount until the text vanishes, while the text comprising the second application state 66 is rendered in expanding amount until the text fills the text scene.

The example 70 of FIG. 5B pertains to a transition 64 between a first application state 62 and a second application state 66, where each application state comprises a two-dimensional graphical scene. The application states in this example 60 are each configured to display and handle a set of user controls comprising a two-dimensional graphical user interface presented as a window form designed to accept and process user input of various types. In this example 70, the first application state 62 displays one form comprising some menu options, some clickable buttons, and some selectable radio buttons, while the second application state 66 displays another form comprising some textboxes and some other clickable buttons. The transition 64 is therefore rendered to transition from one window form to another window form. A transition of this nature therefore operates on the user controls of the scene comprising the application states. In this example 70, the transition 64 applied to the two-dimensional graphical scene moves the user controls comprising the first window form off of the screen in random directions, and moves the user controls comprising the second window form from the borders of the screen onto the window form background in their respective positions. The transition 64 therefore simulates the user controls of the first application state 62 flying off of the window form in various directions and the user controls of the second application state 66 self-assembling onto the window form. For this transition 64, the window form background may remain stationary, since the window form is the same size, shape, and position in both application states. When transitioning between application states having window forms of different sizes, shapes, or positions (or other different attributes, e.g., different window captions or background patterns), the transition 64 might, e.g., morph the window form of the first application state 62 to the window form of the second application state 66.

The example 80 of FIG. 5C pertains to a transition 64 between a first application state 62 and a second application state 66, where each application state comprises a three-dimensional graphical scene. The application states in this example 80 are each configured to display a three-dimensional scene comprising geometric shapes set against a background and rendered from a viewpoint based on ambient features like lighting. The geometric shapes may feature many types of additional visual processing, e.g., texturing, bump mapping, shadowcasting, pixel shading, etc.; and the application state may also feature many types of additional visual processing, e.g., anti-aliasing, anisotropic filtering, etc. In this example 80, the first application state 62 displays one three-dimensional graphical scene comprising some geometric objects (a sphere, a cone, and a cube), while the second application state 66 displays another three-dimensional graphical scene comprising some other geometric objects (a cylinder, a pyramid, and a ring.) The transition 64 is therefore rendered to transition from one three-dimensional scene to another three-dimensional scene. A transition of this nature therefore operates on the geometric objects that comprise the application states. In this example 80, the transition 64 applied to the three-dimensional scene pushes the geometric objects comprising the first application state 62 into the distance and over the horizon, while pushing the geometric objects comprising the second application state 66 into the three-dimensional graphical scene from the foreground.

Application states and transitions therebetween may comprise a wider variety of objects than visual objects. For example, application states may involve tactile elements (e.g., force-feedback communication with the user), communication with peripheral devices such as printers, etc. The example 90 of FIG. 5D pertains to a transition between a first application state 62 and a second application state 66, where each application state comprises an audio scene. The application states in this example 90 are each configured to render a sound that may be appropriate for the semantics of the application state. For example, in an application providing an audio media browsing capability, an application state may comprise a particular form of audio media, e.g., a song from a music library. In this simplified case, a single tone produced by rendering a sine wave, which yields a different pitch for each application state based on the frequency of the sine wave. The transition 64 is therefore rendered to transition from the sounds comprising one audio scene to the sounds comprising another audio scene. A transition of this nature therefore operates on the audio objects that comprise the application states. In this example 90, the transition 64 applied to the audio scene cross-fades the sound objects comprising the first application state 62 (e.g., by rendering them with diminishing amplitude or volume until the sound is inaudible) with the sound objects comprising the second application state 66 (e.g., by rendering them with expanding amplitude or volume until the sound is at full volume.) The transition 64 illustrated in this example 90 is the sum of the tone sound of the first application state 62 at half amplitude (half volume) and the tone sound of the second application state 66 at half amplitude (half volume.)

The examples of FIGS. 5A to 5D illustrate transition between various types of application states and the object components thereof. These transitions may have been provided to the user as stock transitions, or may have been designed by a third party and applied to the application by the user through the pluggable framework, or may have been designed by the user as a custom transition to be rendered in transitioning between particular application states. The illustrations are presented to illustrate the types of scenes and objects that may form various application states, and the types of transitions that may be rendered between such application states. It may be appreciated that a transition 64 may be rendered to transition from the first application state 62 to the second application state 66, and may occasionally also be specified to render the transition from the second application state 66 to the first application state 62. Some transitions may logically relate to both the forward transition and the reverse transition, whereas other transitions may only logically relate to the forward transition, and a second transition may be rendered for the reverse transition. Also, the transitions may be selected to convey some information about the nature of the application state transition, such as “zooming in” to a window that displays a sub-menu and “zooming out” to close the sub-menu window and return to the main application interface.

Another variable aspect of the application states and the transitions that may be rendered therebetween pertains to the interaction of the transitions and the application states. As may be apparent in the transitions depicted in FIGS. 5A-5D, the transitions usually involve manipulating the objects comprising the application states to perform a transition. However, the objects of the application states may be manipulated by the application state upon request of the transition, or may be manipulated directly by the transition. Some advantages and potential disadvantages may arise from each configuration of the pluggable framework. FIGS. 5E and 5F present pseudocode blocks that illustrate contrasting examples of these alternative architectures for rendering a vertical wipe transition between two text-scene application states, such as the vertical wipe transition illustrated in FIG. 5A. It will be appreciated that these pseudocode blocks are not limited to the syntactic or computing constraints of any particular computer language or system architecture. Rather, the pseudocode blocks are provided as a high-level representation of how a transition might variously operate on the objects of the transitioning application states either directly or indirectly through the application states.

FIG. 5E presents a pseudocode block 100 implementing a transition 102 between a prior application state comprising a text scene (such as the first application state 62 of FIG. 5A) and a next application state comprising a text scene (such as the second application state 66 of FIG. 5A), where the transition 102 simulates a vertical wipe between the text scenes. In rendering the vertical wipe, the transition 102 effectuates the rendering of the text objects comprising each text scene. However, the transition 102 does not directly access the text objects; rather, the transition 102 performs a request 104 of each scene to render a bitmap representation of the text objects, and then displays only a portion of each rendered bitmap (along with a vertical line representing the wipe.) The transition 102 therefore does not directly interact with the text objects comprising either text scene. This configuration of the pluggable transition architecture may be advantageous for preventing transition from accessing the objects of an application state, which may present a data security risk; however, the types of transitions that may be so implemented may be limited to those that operate on a text scene through the general-purpose interfaces provided by the application state.

By contrast, FIG. 5F presents a pseudocode block 110 that also implements a transition 112 simulating a vertical wipe between a prior application state comprising a text scene (such as the first application state 62 of FIG. 5A) and a next application state comprising a text scene (such as the second application state 66 of FIG. 5A.) In this configuration, the transition 112 performs direct accesses 114 of the text objects comprising the text scenes of the prior application state and the next application state while rendering such portions of each text scene so as to simulate the vertical wipe. The transition 112 therefore directly interacts with the text objects comprising the application states. By contrast with the restricted-access transition architecture involved in FIG. 5D, this configuration may enable a wider range of transitions on the scenes comprising various application states, but may also present a security risk by exposing the objects comprising the application states to the instructions comprising the transition.

Another variable aspect of the transitions rendered between application states pertains to the event triggering the transition between the application states. In the examples presented in FIGS. 5A-5D, each shift from a first application state to a second application state is associated with a particular transition to be rendered therebetween. The pluggable transition techniques disclosed herein may be provided to permit a user (such as a software developer) to specify a custom transition to be rendered between a first application state and a second application state. However, alternative types of associations of transitions with application states may be provided and configured while implementing the techniques disclosed herein.

FIG. 5G illustrates one such alternative association, wherein an application state is configured to render a plurality of transitions while transitioning to and/or from another application state. In this example 120, a first application state 64 includes both a two-dimensional graphical scene comprising two-dimensional visual objects and an audio scene comprising a sound object; and a second application state 66 includes both another two-dimensional graphical scene comprising other two-dimensional visual objects and another audio scene comprising another sound object. These application states are associated with both a two-dimensional graphical scene transition for transitionally rendering the two-dimensional visual objects of the application state, and an audio scene transition for transitionally rendering the sound objects of the application state. The transitions may be rendered in sequence or in parallel to effectuate the transition from the first application state 62 to the second application state 66.

FIG. 5H illustrates another such association, wherein an application state is configured to select and render one of a plurality of transition states while transitioning to or from another application state based on a transition circumstance. This illustration provides an example 130 in which a first application state 62 and a second application state 66 are associated with two transitions: a flying two-dimensional object transition 132 (such as the transition 64 of FIG. 5B), and a cross-fading transition 134. Both transitions are configured to be rendered upon transitioning from the first application state 62 to the second application state 66. However, rather than rendering both transitions (as in the example of FIG. 5G), the application in this example 130 is configured to select one of the two transitions based on the transition circumstance, i.e., based on the nature of the event triggering the transition from the first application state 62 to the second application state 66. The application is configured to render the cross-fading transition 134 between the first application state 62 to the second application state 66 upon the receipt of a “Click” event for the “OK” button of the first application state 62, and to render the flying two-dimensional object transition 132 between the first application state 62 and the second application state 66 upon the receipt of a “Click” event for the “Cancel” button of the first application state 62. Hence, the transition condition (clicking the “OK” button vs. clicking the “Cancel” button) is the basis for the application selecting one of the transitions associated with the transition from the first application state 62 to the second application state 66.

In a third such association, an object of an application state may be associated with the custom transition, and the application may be configured to render the custom transition defined in the custom transition module upon transition between two application states where either or both of the application states includes the associated object. For example, an application may include a translucent button class, and a custom transition may be defined to fade the translucent buttons of an application state into or out of view upon displaying or disposing any application state that includes the translucent buttons. In one embodiment, the architecture may provide this functionality to the user by defining a property of an object (e.g., a Transition property) that the user may associate with a custom transition module in order to render the custom transition for each application state that includes the object.

The pluggable transition architecture may be configured to provide the customizable transitions between application states as described herein. As indicated in the exemplary method 20 of FIG. 2 and the exemplary system 30 of FIG. 3, such embodiments involve handling the receipt of a custom transition module, and the configuration of the application to render the transition between two specified application states.

The custom transition module may be provided to the pluggable architecture in a variety of manners. For example, in an application development environment, a software developer may prepare a solution comprising a first project containing the application defining a plurality of application states, and may also create in the same solution a second project containing a custom transition module defining one or more custom transitions. The software developer may then reference the second project from the first project in order to provide the custom transition module, and the application development environment may receive the custom transition module and associate it with the first project upon building the solution (e.g., by configuring the second project as a build dependency of the first project.) As another example, a user may reference a custom transition module from outside the solution, e.g., by browsing and selecting a file comprising the custom transition module (such as a source code file, a partially or wholly compiled binary comprising a dynamic link library, etc.), or by dragging and dropping a file or icon onto the graphic designer comprising the project. This custom transition module may have been designed by the user outside of the current solution, or may have been provided to the user by a third party and plugged into the application through the custom transition pluggable application development environment. Those of ordinary skill in the art may devise a variety of techniques for providing a custom transition module to a pluggable architecture, and for configuring the pluggable architecture to receive the custom transition module and register it with the application, while implementing the techniques described herein.

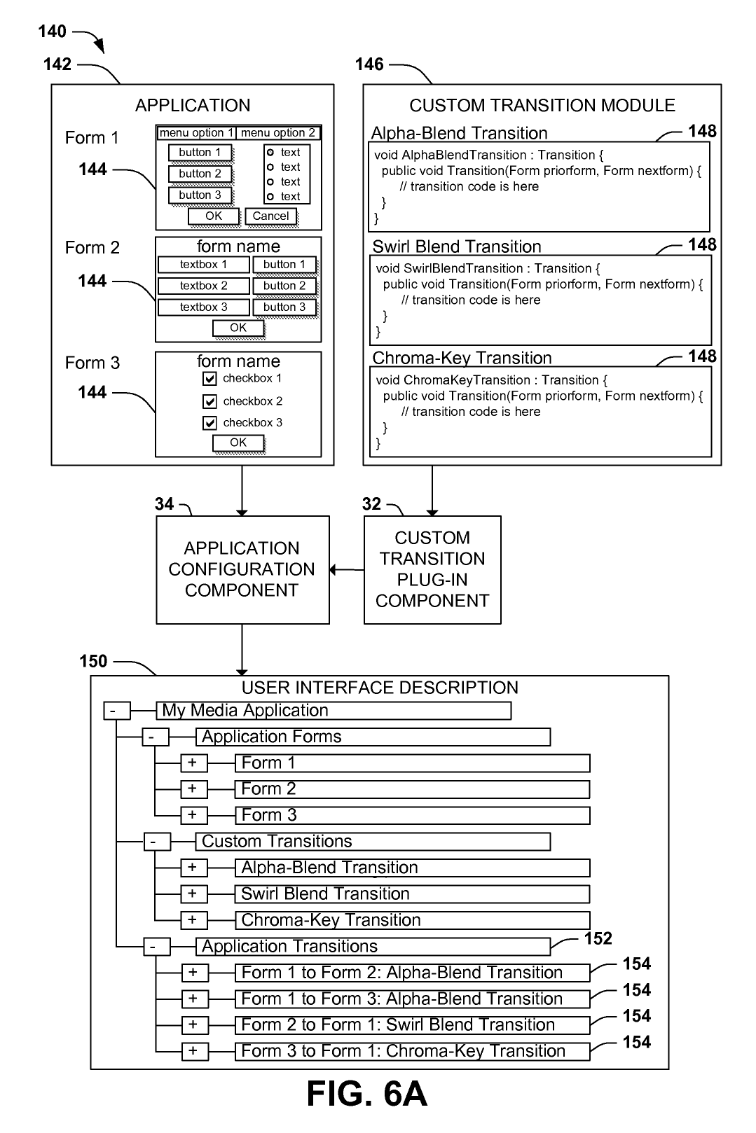

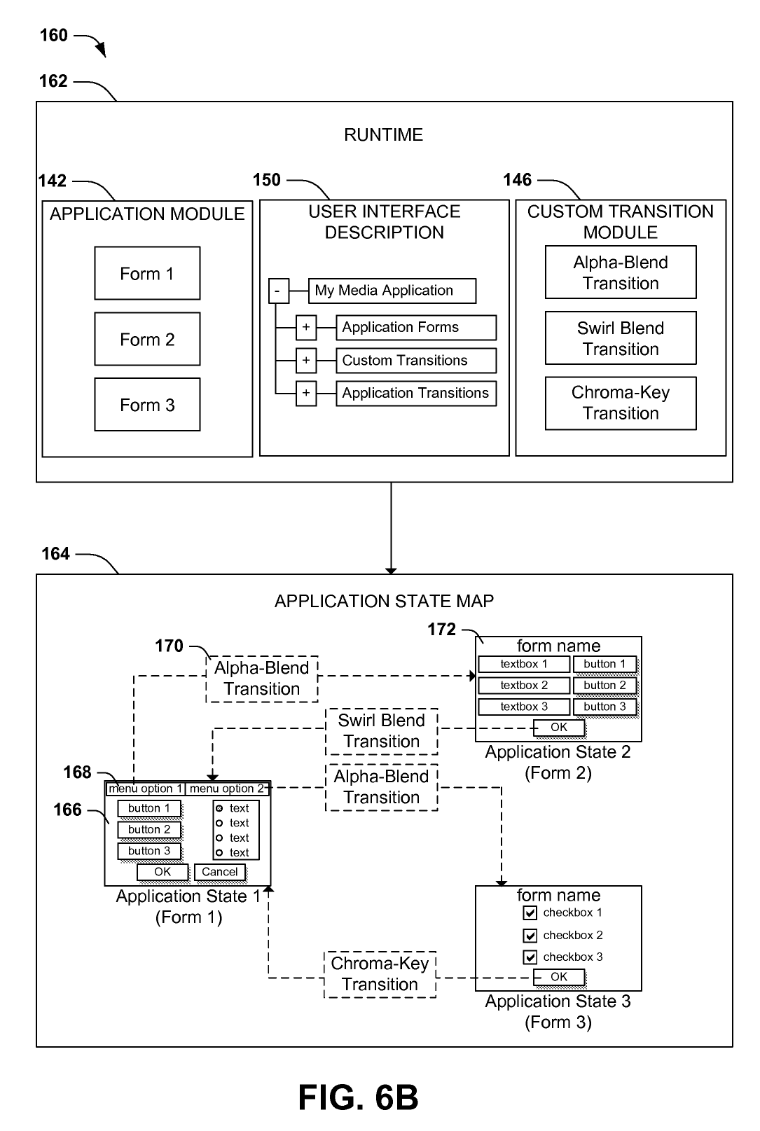

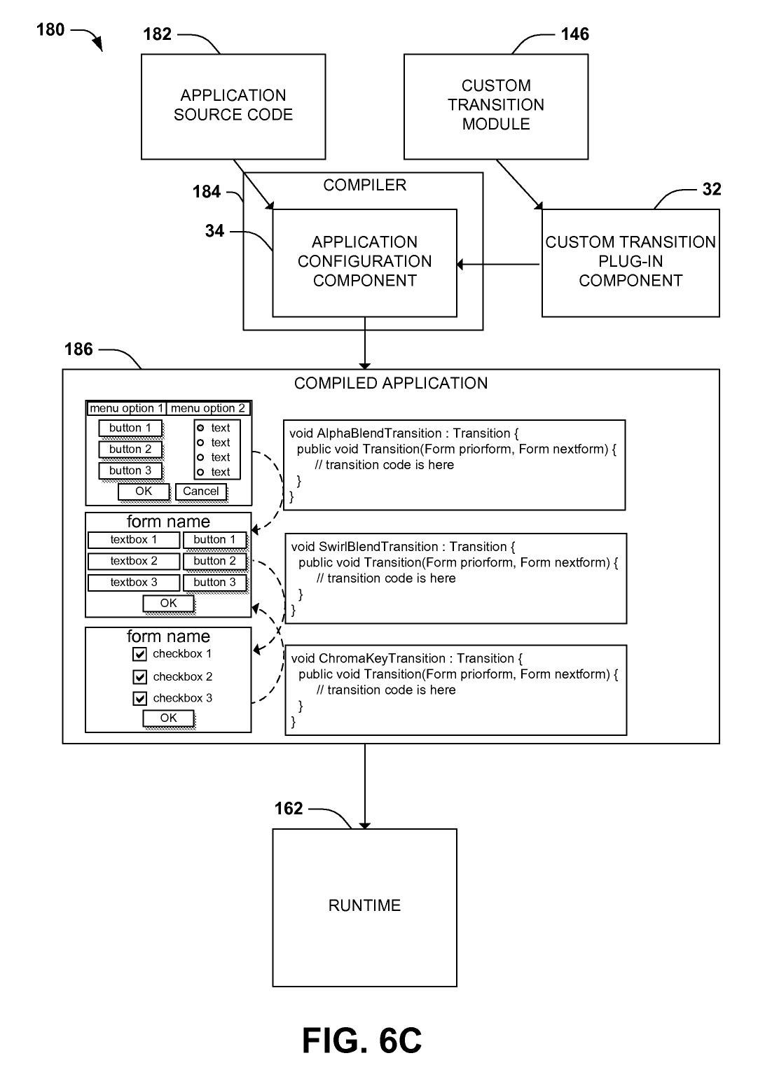

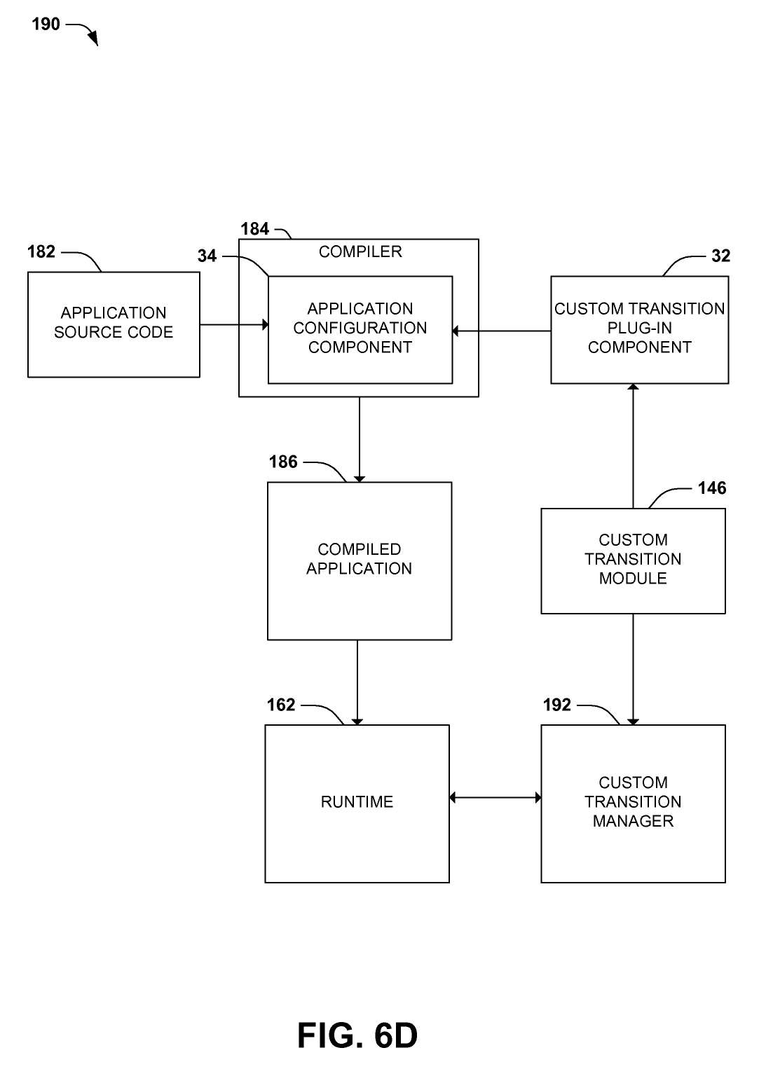

The pluggable architecture also configures the application to render a custom transition between a first application state and a second application state, as may be specified by the user. Many techniques are available for configuring the application in this manner. One example 140 is illustrated in FIG. 6A, which illustrates one embodiment of the exemplary system 30 of FIG. 3 comprising a custom transition plug-in component 32 and an application configuration component 34. In this example 140, an application 142 defining a set of window forms 144 is coupled with a custom transition module 146 defining a set of custom transitions 148. The custom transition plug-in component 32 receives the custom transition module 146, and the application configuration component 34 configures the application 142 to render the custom transitions 148 of the custom transition module 146 between the application states represented by the window forms 144 of the application 142. In this example 140, the configuring comprises referencing the custom transition module 146 to be rendered upon transitioning between various application states in a user interface description 150 associated with the application 142. The user interface description 150 provides a description of the components of the application 142 (e.g., some details about the application forms 144) and the interrelationships thereof. This information includes a description of the set of application transitions 152, which may include associations 154 of the custom transitions 148 with transitions between various application states, such as transitions between the window forms 144 of the application 142. The information may also specify, e.g., a plurality of transitions to be rendered in sequence or in parallel while transitioning between two application states; or a plurality of transitions to be rendered while transitioning between two application states and a transition circumstance upon which to select an appropriate transition; or an object associated with a custom transition to be rendered while transitioning to or from an application state containing the object.

Many techniques may be available for coupling the user interface description 150 with the compiled version of the application 142. As one example, the user interface description 150 may be included with the compiled version of the application 142, e.g., by building it into the resource manifest of the compiled binary. As another example, the user interface description 150 may be stored as an application configuration file collocated with the compiled binary. The user interface description 150 may also be written according to many data storage techniques and formats. One such format that may be advantageous is a structured document format, such as an XML format, and more particularly an Extensible Application Markup Language (XAML) format. Those of ordinary skill in the art may be able to devise many such descriptors and formatting and storage thereof while implementing the techniques described herein.

A user interface description file may be processed with an application by various computer systems in order to render the custom transitions during the transitions between application states of the application. One such computer system 160 is illustrated in FIG. 6B, in which a runtime 162 is implemented to service and manage the execution of the process comprising the application. Upon invocation of the application, the runtime 162 loads the application module 142 and the associated user interface description 150. Upon examining the user interface description 150, the runtime 162 encounters the reference to the custom transition module 146 and loads the custom transition module 146 in order to render the custom transitions contained therein. The runtime 162 therefore produces a process that operates in accordance with the application state map 164 of FIG. 6B, in which the application states represented by various window forms are coupled with custom transitions to be rendered between various application states. For example, when the application is in a first application state displaying the first window form 166, the user may select the first menu option 168 to transition to a second application state represented by the second window form 172. This transition invokes the alpha-blend transition 170 in accordance with the user interface description 150, and the runtime 162 renders the alpha-blend transition 170 while transitioning from the first application state to the second application state. Other transitions are also shown in the application state map 164 for transitioning between application states though particular custom transitions, as defined by the user interface description 150.

Another exemplary system 180 is illustrated in FIG. 6C, again featuring a custom transition plug-in component 32 configured to receive an custom transition module 146 and an application configuration component 182 configured to configure an application to render a custom transition between a first application state and a second application state. In this exemplary system 180, the application configuration component is included in the compiler 184, which operates on the source code of the application and produces a compiled application 186. In this exemplary system 180, the application configuration component 34 is configured to build the custom transition module 146 into the compiled application 186, e.g., as an embedded resource or a partially or wholly compiled set of classes and objects. The compiled application 186 is also configured by the application configuration component 34 to render the custom transitions while transitioning between various application states, e.g., by inserting auto-generated code comprising event monitors and handlers that trigger the rendering of the custom transitions in response to application state transitions. The compiled application 186 therefore defines a set of application states and transitions therebetween similar to the application state map 164 of FIG. 6B. The compiled application 186 may then be invoked by providing it to a runtime 162 that loads the compiled application 186 (including the custom transition module 146 embedded therein) and conforms with the configuration of the application in rendering the custom transitions between various application states.

FIG. 6C illustrates yet another exemplary system 190, which, similarly to the system of FIG. 6C, features a custom transition plug-in component 32 configured to receive a custom transition module 146 defining at least one custom transition. This exemplary system 190 also features an application configuration component 34 associated with a compiler 184 that together read an application source code 182 and produce a compiled application 186 in which custom transitions are invoked while transitioning between various application states. This exemplary system 190 also features a runtime 162 configured to load the compiled application 186 upon invocation, and to manage the process executing the instructions of the compiled application 186. However, instead of inserting auto-generated code in the compiled application 186, the compiler 184 and application configuration component 34 may insert some high-level indicators in the compiled application 186 to indicate the custom transitions to be rendered upon transitioning between various application states. The high-level indicators may be as simple as recording in a property of a window form, or a user control embedded therein, with the name of the custom transition to be rendered upon displaying, invoking, or disposing the window form or the user control. Upon encountering such an indicator, the runtime 162 may refer to a custom transition manager 192, which may be configured to manage the rendering of the custom transition while the process transitions between application states. The custom transition manager 192 may be invoked by the runtime 162, and may be configured to receive the custom transition module 146 and to render it as part of the process managed by the runtime 162. The custom transition manager 192 may therefore offload from the runtime 162 the specialized computing burden of the custom transition management and rendering, and may avoid the insertion of auto-generated code in the compiled application 186 that may be unduly redundant or complicated. In one such embodiment, the custom transition module may be a resource provided within or alongside the runtime 162, or may be provided by the computer system, e.g., as part of an application programming interface (API) that the compiled application 186 invokes through the runtime 162. In another such embodiment, the custom transition manager 192 may be compiled with the application 182 into the compiled application 186, and the application configuration component 34 may configure the application to render the custom transition between various application states by invoking the custom transition manager 192 compiled into the compiled application 186. Those of ordinary skill in the art may be able to devise other techniques (e.g., other systems and methods, and other computer-readable media embodying same) for managing the rendering of custom transitions between application states as disclosed herein. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it may be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of configuring an application to render a custom transition between a first application state and a second application state, the method comprising:
receiving a custom transition module defining the custom transition, and configuring the application to render the custom transition upon transitioning between the first application state and the second application state.

2. The method of claim 1, at least one of the first application state and the second transition state comprising one of a text scene, a two-dimensional graphical scene, a three-dimensional graphical scene, and an audio scene.

3. The method of claim 1, the configuring comprising configuring the application to supply to the custom transition module at least one object comprising at least one of the first application state and the second application state.

4. The method of claim 3, the objects comprising at least one of a text object, a video object, a two-dimensional visual object, a three-dimensional visual object, and a sound object.

5. The method of claim 3, at least one object associated with the custom transition, and the configuring comprising configuring the application to render the custom transition upon transition between at least one of a first application state including the associated object and a second application state including the associated object.

6. The method of claim 1, the configuring comprising configuring the application to render the custom transition upon transitioning with a transition circumstances between the first application state and the second application.

7. The method of claim 1, the configuring comprising:
referencing the custom transition module to be rendered upon transitioning between the first application state and the second application state in a user interface description associated with the application.

8. The method of claim 1, the configuring comprising:
compiling the application with the custom transition module, and
configuring the application to render the custom transition in the included custom transition module between the first application state and the second application state.

9. The method of claim 1, the application configured to render the custom transition by invoking a custom transition manager with the custom transition module.

10. The method of claim 9, the configuring comprising:
compiling the application with the custom transition manager, and
configuring the application to render the custom transition between the first application state and the second application state by invoking the included custom transition manager with the custom transition module.

11. A computer-readable medium comprising processor-executable instructions for performing the method of configuring an application to render a custom transition between a first application state and a second application state, the method comprising:
receiving a custom transition module defining the custom transition, and
configuring the application to render the custom transition upon transitioning between the first application state and the second application state.

12. A system for configuring an application to render a custom transition between a first application state and a second application state, the system comprising:
a custom transition plug-in component configured to receive a custom transition module defining the custom transition, and
an application configuration component configured to configure the application to render the custom transition provided to the custom transition plug-in component upon transitioning between the first application state and the second application state.

13. The system of claim 12, at least one of the first application state and the second transition state comprising one of a text scene, a two-dimensional graphical scene, a three-dimensional graphical scene, and an audio scene.

14. The system of claim 12, the application configuration component configured to configure the application to supply to the custom transition module at least one object comprising at least one of the first application state and the second application state.

15. The system of claim 14, the object comprising at least one of a text object, a video object, a two-dimensional visual object, a three-dimensional visual object, and a sound object.

16. The system of claim 14, at least one object associated with the custom transition, and the configuring comprising configuring the application to render the custom transition upon transition between at least one of a first application state including the associated object and a second application state including the associated object.

17. The system of claim 12, the application configuration component configured to configure the application by referencing the custom transition module to be rendered upon transitioning between the first application state and the second application state in a user interface description associated with the application.

18. The system of claim 12, the application configuration component configured to compile the application with the custom transition module.

19. The system of claim 12, comprising a custom transition manager configured to render the custom transition between the first application state and the second application state, and the application configuration component configured to configure the application to render the custom transition by invoking the custom transition manager with the custom transition module.

20. The system of claim 19, the application configuration component configured to compile the application with the custom transition manager.
